(19) United States
(12) Patent Application Publication
(10) Pub. No.: US 2016/0226311 A1
(43) Pub. Date: Aug. 4, 2016

(54) POWER TRANSMISSION DEVICE, POWER TRANSMISSION AND RECEIVING DEVICE, METHOD FOR DETECTING POWER RECEIVING DEVICE, POWER RECEIVING DEVICE DETECTION PROGRAM, AND SEMICONDUCTOR DEVICE

(71) Applicant: DEXERIALS CORPORATION, Tokyo (JP)

(72) Inventor: Masayoshi KANNO, Tochigi (JP)

(21) Appl. No.: 14/777,688

(22) PCT Filed: Mar. 11, 2014
(86) PCT No.: PCT/JP2014/056317

§ 371 Date: Sep. 16, 2015

(30) Foreign Application Priority Data
Mar. 22, 2013 (JP) 2013-060646

(51) Int. Cl. H02J 50/12; H02J 50/80; H02J 50/60

(52) U.S. Cl. CPC H02J 50/12; H02J 50/60; H02J 50/80

(57) ABSTRACT

To provide a power transmission device that can accurately discriminate a device or apparatus placed on a secondary side from a foreign object placed on the secondary side without adding a complex circuit. The power transmission device includes a control unit that sets a drive frequency of a signal for driving a resonance circuit, an inverter unit that drives the resonance circuit at three or more drive frequencies on the basis of a setting of the control unit, and a waveform monitor unit that detects a drive waveform of the resonance circuit. The control unit sets three or more drive frequencies according to a procedure of a program stored in a storage unit, compares signal data at the drive frequencies detected by a drive waveform detecting unit with each other, and detects a power receiving device on the basis of the comparison result.

### BACKGROUND OF THE INVENTION

1. Field of the Invention

This invention relates to a power transmission device, a power transmission and receiving device, a method for detecting power receiving device, a power receiving device detection program, and a semiconductor device that transmit or receive an electric power from a noncontact communication device. The present application claims priority based on Japanese Patent Application No. 2013-60646 filed in Japan on Mar. 22, 2013. The total contents of the patent application are to be incorporated by reference into the present application.

2. Description of Related Art

A noncontact communication technique using electromagnetic induction has been popularly applied to IC cards such as FeliCa (registered trademark), Mifare (registered trademark), and NFC (Near Filed Communication). In recent years, the noncontact communication technique has been also applied to a noncontact power charging (discharging) technique typified by Qi format and has been popularly used in wide ranges. In the field of the noncontact charging technique, in order to apply the noncontact communication technique to not only a mobile information terminal but also an electric automobile or the like, a technique which is called a magnetic resonance scheme and can transmit an electric power to a distant position has been actively developed. In fact, even in the electromagnetic induction scheme or a magnetic resonance scheme, since an electric power is transmitted or received by using a resonance circuit, the electromagnetic induction scheme and the magnetic resonance scheme can be equally handled.

Also in noncontact communication performed between a noncontact IC card and a reader/writer, as in noncontact charging which transmits or receives a relatively high electric power, the electric power must be transmitted from a primary side (reader/writer or power transmission device) to a secondary side (noncontact IC card or power receiving device). In this case, the primary side recognizes whether the party (IC card or power receiving device) to which an electric power should be transmitted is present on the secondary side. Furthermore, even though the other party is present on the secondary side, the primary side must recognize whether other party is a party to which an electric power should be transmitted. For example, as shown in FIG. 16, the primary side transmits a detection signal to the secondary side to activate the secondary side (step S20), a device or apparatus on the secondary side is operated by using the transmitted signal as an electric power to respond to the primary side (step S21). Thereafter, the device on the primary side transmits a signal for apparatus authentication to the device or apparatus on the secondary side to wait for an authentication response and a requested electric power response from the secondary side (step S22). The device on the primary side is set in a power receiving mode which transmits a requested electric power when the device or apparatus on the secondary side can be authenticated, and performs error handling such as operation stop when the device or apparatus cannot be authenticated (step S23). In each of the noncontact communication system or the noncontact power charging system, a power transmission protocol is devised.

In this case, since the device on the primary side does not know when the device or apparatus on the secondary side enters a communication area on the primary side, the device on the primary side generates and always transmits signals (called polling signals) to detect the device or apparatus on the secondary side at predetermined intervals.

When polling is regularly performed, in a mobile phone, a smart phone, or the like operated with a battery, a power consumption increases. For this reason, it is strongly requested that a device or apparatus on the secondary side should be detected at a minimum power consumption.

### PRIOR-ART DOCUMENTS

### Patent Document

Patent document 1: Japanese Patent Application Laid-Open No. 2009-033782

### BRIEF SUMMARY OF THE INVENTION

### Problems to be Solved by the Invention

In order to suppress a power consumption in a polling operation, methods such as a method of elongating a polling cycle and a method of lowering an output of a transmission electric power for polling are conceived. However, when the polling cycle is elongated, a detection time becomes long. When the transmission electric power is lowered, a detection area becomes small.

When the device or apparatus on the secondary side is tried to be detected without waiting a response from the secondary side, a transmission time per polling can be shortened.

When the device or apparatus on the secondary side enters a communication area of the device on the primary side, magnetic coupling between the primary side and the secondary side occurs, a current flowing in an antenna on the primary side may decrease, or a current waveform changes. However, even though a foreign object such as a metal plate is present on the secondary side, since magnetic coupling occurs, a change in waveform on the primary side occurs. In this manner, the device on the primary side must be prevented from recognizing a party to which an electric power should not be transmitted as a “foreign object” and from transmitting the electric power to the party.

For example, in Patent document 1 discloses a technique that detects a foreign object such as a metal on the secondary side by using the characteristic of the change in current on the primary side as described above. However, in this method, the configuration of a circuit that acquires current waveforms and make a determination to detect a difference between current waveforms flowing in the antenna at frequencies between a resonance frequency on the primary side and an operation frequency in a normal operation is disadvantageously complicated. The circuit is further complicated to correct a fluctuation or a variation in resonance frequency the device or apparatus placed on the secondary side has, and the resonance frequencies are difficult to be adjusted.

Thus, it is an object of the present invention to provide a power transmission device, a power transmission and receiving device, a method for detecting power receiving device, a power receiving device detection program, and a semiconductor device which can accurately discriminate a device or apparatus placed on a secondary side from an foreign object without adding a complex circuit.

### Means to Solve the Problem

As a means to solve the above problem, a power transmission device according to an embodiment of the present invention is a power transmission device that transmits an electric power to a power receiving device in a noncontact state by using a resonance circuit. This power transmission device includes a control unit that sets a drive frequency of a signal for driving the resonance circuit, a drive unit that drives the resonance circuit at three or more drive frequencies on the basis of a setting of the control unit, and a drive waveform detecting unit that detects a drive waveform of the resonance circuit. The control unit sets the three or more drive frequencies, compares signal data at the drive frequencies detected by the drive waveform detecting unit with each other, and detects a power receiving device on the basis of the comparison result.

A power transmission and receiving device according to another embodiment of the present invention is a power transmission and receiving device that transmits an electric power to a power receiving device or another power transmission and receiving device in a noncontact state by using a resonance circuit.

The power transmission and receiving device includes a control unit that sets a drive frequency of a signal for driving a resonance circuit, a drive unit that drives the resonance circuit at three or more drive frequencies on the basis of a setting of the control unit, and a drive waveform detecting unit that detects a drive waveform of the resonance circuit. The control unit sets the three or more drive frequencies, compares signal data at the drive frequencies detected by the drive waveform detecting unit with each other, and detects a power receiving device or another power transmission and receiving device on the basis of the comparison result.

A method for detecting power receiving device according to still another embodiment of the present invention is a method for detecting power receiving device that detects, when an electric power is transmitted from a power transmission device to the power receiving device in a noncontact state by using a resonance circuit, the presence/absence of a power receiving device. In the method for detecting power receiving device, a control unit sets a drive frequency of a signal for driving a resonance circuit, a drive unit, on the basis of a setting of the control unit, drives the resonance circuit at three or more drive frequencies, and a drive waveform detecting unit detects a drive waveform of the resonance circuit. The control unit sets three or more drive frequencies, compares signal data at the drive frequencies detected by the drive waveform detecting unit with each other, and detects a power receiving device on the basis of the comparison result.

a power receiving device detection program according to still another embodiment of the present invention is a received power adjustment program for a noncontact charging power receiving device including a storage unit in which a program is stored and a control unit having a processing unit that develops and executes the stored program, and is a power receiving device detection program that, when an electric power is transmitted from a power transmission device to a power receiving device in a noncontact state by using a resonance circuit, detects the presence/absence of a power receiving device. The power receiving device detection program includes the step of setting a drive frequency of a signal for driving a resonance circuit by the control unit, the step of driving the resonance circuit at three or more drive frequencies on the basis of a setting of the control unit by a drive unit, the step of detecting a drive waveform of the resonance circuit by a drive waveform detecting unit. The control unit sets three or more drive frequencies, compares signal data at the drive frequencies detected by the drive waveform detecting unit with each other, and detects a power receiving device on the basis of the comparison result.

A semiconductor device according to still another embodiment of the present invention includes a storage unit in which a power receiving device detection program is stored.

The semiconductor device according to still another embodiment of the present invention further includes a control unit that develops and executes a received power adjustment program.

### Effects of Invention

According to the present invention, since the resonance circuit is driven at the three or more drive frequencies, a difference between a drive current waveform obtained when a power receiving device is disposed and a drive current waveform obtained when a foreign object such as a metal is disposed is clear, and the power receiving device can be easily detected within a short period of time.

### BRIEF DESCRIPTION OF THE SEVERAL VIEWS OF THE DRAWINGS

FIG. 1 is a block diagram showing a configuration of a power transmission device according to an embodiment to which the present invention is applied.

FIG. 2A is a block diagram showing a configuration of a main part of a power transmission system including the power receiving device according to an embodiment to which the present invention is applied. FIG. 2B is a block diagram showing a configuration of a resonance circuit in a detail of FIG. 2A.

FIGS. 3A and 3B are circuit diagrams showing a configuration to change resonance frequencies of the resonance circuit. FIG. 3A shows a case in which a variable capacitor is used as a resonance capacitor, and FIG. 3B shows an example in which a fixed capacitor is used as the resonance capacitor.

FIG. 4A is a graph showing an example of a DC bias dependence of an electric capacitance of the variable capacitor, and FIG. 4B is a graph showing an example of a DC bias dependence of a resonance frequency of a resonance circuit using a variable capacitor in FIG. 4A.

FIGS. 5A and 5B are conceptual diagrams showing frequency characteristics of the values of currents flowing in circuits on a power transmission side and a power receiving side. FIG. 5A shows a case in which a metal having no frequency characteristics is disposed on the power receiving side, and FIG. 5B shows the presence/absence of a change in frequency characteristic on the power transmission side when a resonance circuit having the same resonance frequency as that on the power transmission side is disposed on the power receiving side.

FIG. 6A shows an actual measurement value of a frequency characteristic of a current flowing in a resonance circuit on a power transmission side when a metal is disposed on a power receiving side, and FIG. 6B shows an actual measurement value of a frequency characteristic on the power transmission side when a resonance circuit having the same resonance frequency as that on the power transmission side is disposed on the power receiving side.

FIG. 7 is a conceptual diagram showing frequency characteristics of current values at three drive frequencies flowing in circuits on a power transmission side and a power receiving side in weak coupling.

FIG. 8 is a graph showing actual measurement values of frequency characteristics of currents in a resonance circuit when resonance frequencies of a resonance circuit on a power transmission side are changed to detect a device on a power receiving side in weak coupling, and showing a case in which a metal is disposed on the power receiving side.

FIG. 9 is a graph showing actual measurement values of frequency characteristics of currents in a resonance circuit when resonance frequencies of a resonance circuit on a power transmission side are changed to detect a device on a power receiving side in weak coupling, and showing a case in which a resonance circuit having the same resonance frequency as that on the power transmission side is disposed on the power receiving side.

FIG. 10 is a graph showing actual measurement values of frequency characteristics of currents in a resonance circuit when resonance frequencies of a resonance circuit on a power transmission side are changed to detect a device on a power receiving side in weak coupling, and showing a case in which a resonance circuit having a resonance frequency higher than that on the power transmission side is disposed on the power receiving side.

FIGS. 11A and 11B are diagrams for explaining a detection procedure used when a distance between a device on a power receiving side and a device on a power transmission side is shortened with passage of time. FIG. 11A shows a case in which a drive frequency f0 of three drive frequencies f01, f0, and f02 is performed first, and FIG. 11B shows a case in which the drive frequency f0 of the three drive frequencies f01, f0, and f02 is performed at the last.

FIGS. 12A to 12E show detection patterns obtained by comparing currents flowing in a resonance circuit on a power transmission side on the same frequency characteristic. FIG. 12A shows an upward-sloping pattern, FIG. 12B shows a downward-sloping pattern, FIG. 12C shows a convex-upward pattern, FIG. 12D showing a convex-downward pattern, and FIG. 12E shows a flat pattern.

FIG. 13A to FIG. 13D show weak coupling patterns when the patterns in FIG. 12A to 12E are applied while the resonance frequency of the resonance circuit on the power transmission side is changed. FIG. 13A shows a weak coupling pattern obtained when the maximum value of a current flowing in each of the resonance circuits is flat, FIG. 13B shows a weak coupling pattern obtained when the maximum value of a current flowing in a resonance circuit having a central resonance frequency (equal to the resonance frequency on the power receiving side) is lower than the maximum values of currents flowing in the other resonance circuits, FIG. 13C shows a weak coupling pattern obtained when the maximum value of a flowing current decreases when the resonance frequency of the resonance circuit increases, and FIG. 13D shows a weak coupling pattern obtained when the maximum value of a flowing current increases when the resonance frequency of the resonance circuit increases.

FIG. 14 is a flow chart for explaining a method for detecting power receiving device according to one embodiment of the present invention.

FIG. 15 is a block diagram showing a configuration of a power transmission and receiving device according to another embodiment of the present invention.

FIG. 16 is a flow chart showing a power receiving device detection procedure used in a conventional noncontact charging device or a noncontact communication device.

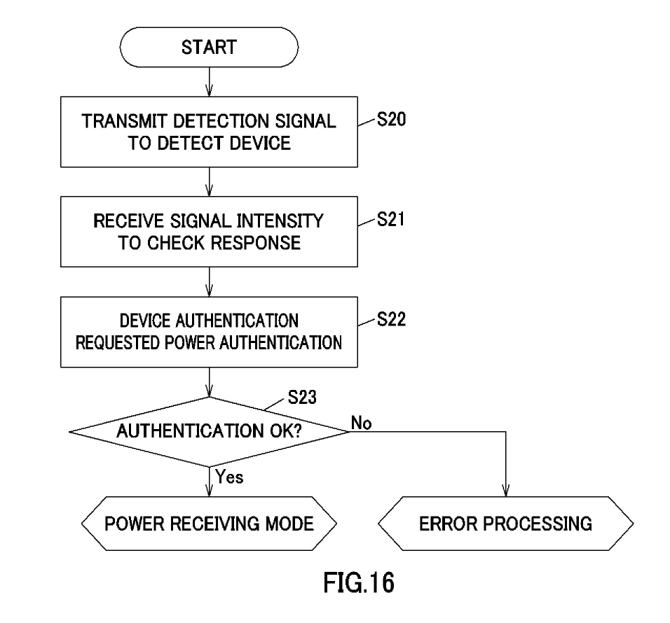

### DETAILED DESCRIPTION OF THE INVENTION

Modes for executing the present invention will be described below in detail with reference to the accompanying drawings. The present invention is not limited to only the following embodiments, and can be variously changed without departing from the spirit and scope of the present invention as a matter of course. The explanation will be made in the following order.

1. Configuration of power transmission device

2. Principle and operation of power transmission device

2-1. Difference between frequency characteristics of antenna currents in the presence of power receiving device and in the presence of foreign object

2-2. Detection of difference between frequency characteristics of antenna currents in weak coupling

2-3. Resonance frequency deviation on power receiving device side

2-4. Detection of difference between frequency characteristics of antenna currents when a coupling coefficient changes

2-5. Setting of detection pattern

3. Method for detecting power receiving device

4. Configuration of power transmission and receiving device

1. Configuration of Power Transmission Device

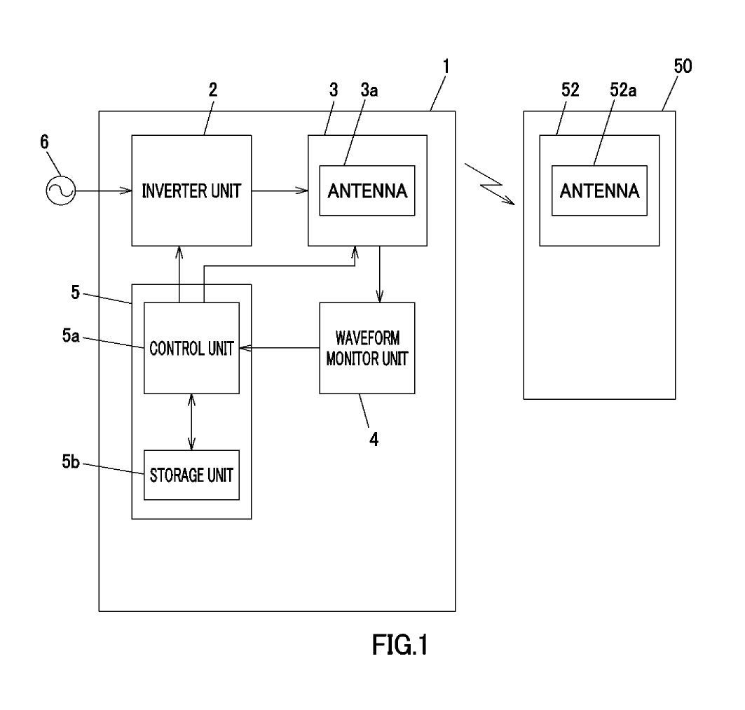

As shown in FIG. 1, a power transmission device 1 according to one embodiment to which the present invention is applied includes a transmission and receiving unit 3 having a primary side antenna 3a electromagnetically coupled to a secondary side antenna 52a included in a power receiving device 50. The power transmission device 1 includes an inverter unit 2 that converts the frequency of a commercial power supply 6 (or a DC power output from a solar power generation system) into a predetermined drive frequency to drive the primary side antenna 3a of the transmission and receiving unit 3. The power transmission device 1 includes a waveform monitor unit 4 that acquires a current waveform of the primary side antenna 3a and a control system unit 5 that sets a drive frequency to the inverter unit 2 on the basis of a current value acquired by the waveform monitor unit 4.

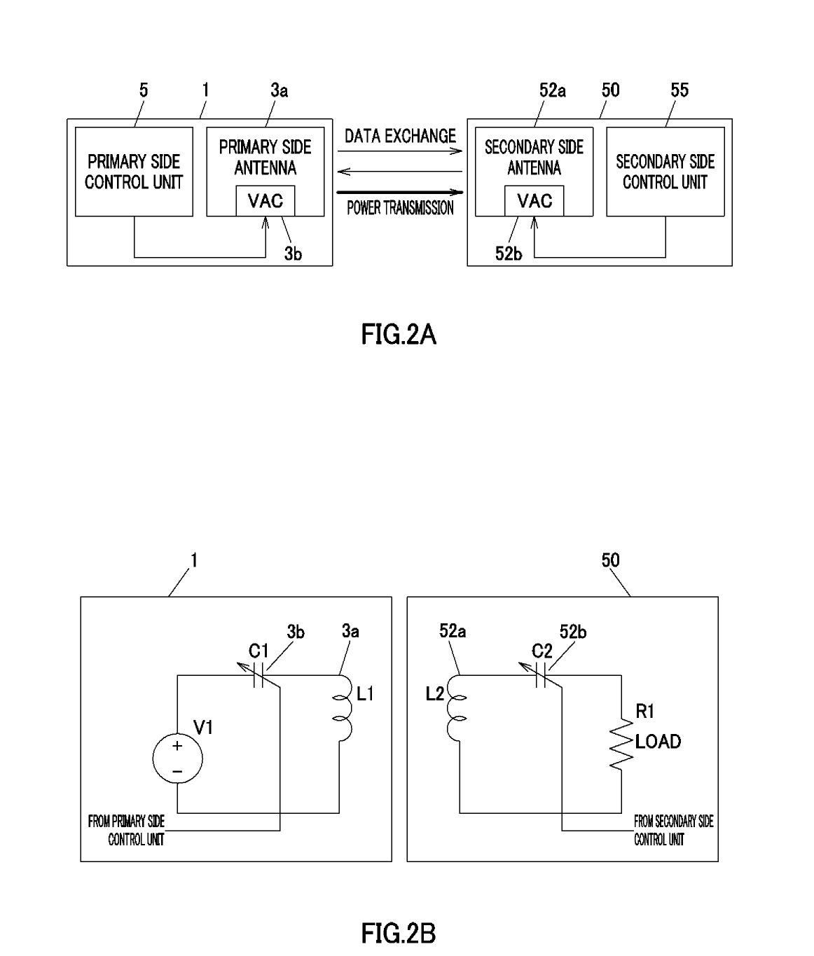

The transmission and receiving unit 3 as shown in FIGS. 2A and 2B has the primary side antenna 3a and a variable capacitor VAC 3b serving as a resonance capacitor which determines an inductance of the primary side antenna 3a and a resonance frequency. The secondary side (power receiving device 50) transmission and receiving unit 52 has, as shown in FIGS. 2A and 2B the same configuration as that of the transmission and receiving unit 3, and has the secondary side antenna 52a and the variable capacitor VAC 52b serving as a resonance capacitor which determines an inductance of the secondary side antenna 52a and a resonance frequency on the secondary side. In an IC card for noncontact communication, a resonance capacitor has a fixed capacitance.

More specifically, as shown in FIGS. 2A and 2B, the primary side antenna 3a of the power transmission device 1 and a variable capacitor 3b serving as a resonance capacitor configure a resonance circuit. As will be described later, a resonance frequency of the resonance circuit can change a set value such that a DC bias voltage across both the ends of the variable capacitor 3b by an instruction from the primary side (power transmission device 1) control system unit 5. A capacitance of the variable capacitor 52b connected to the secondary side antenna 52a may be changed with respect to a resonance frequency on the secondary side (power receiving device 50) on the basis of an instruction from a secondary side control system unit 55 to make it possible to change the resonance frequency.

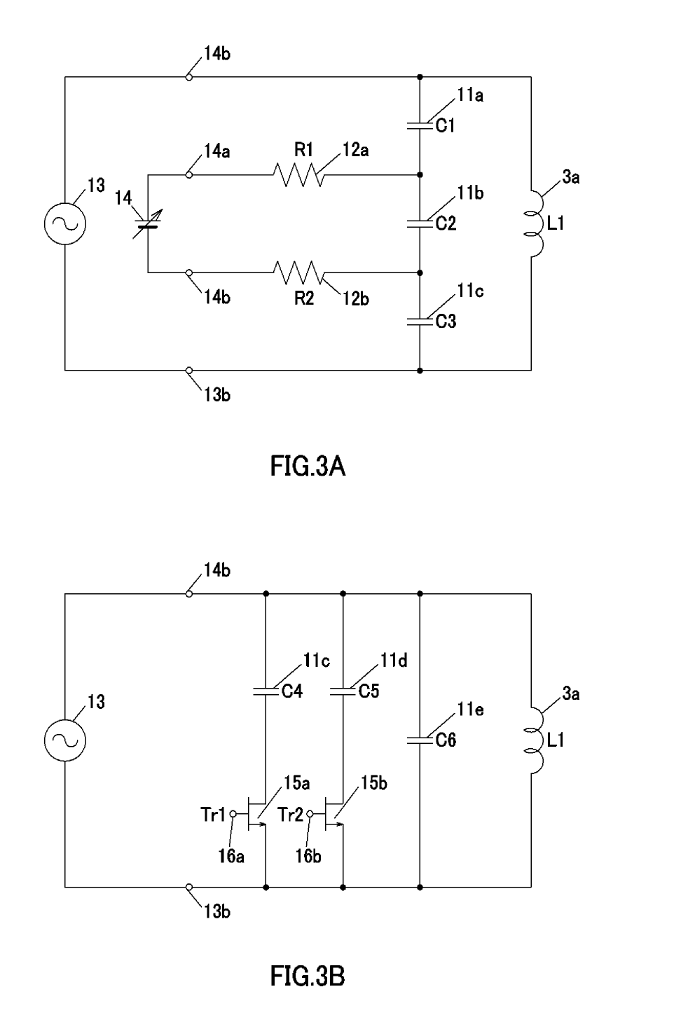

As shown in FIG. 3A, a resonance capacitor is connected in series with or in parallel with the primary side antenna 3a (inductance L1). In FIG. 3A, an example in which a variable capacitor (C2) 11b is connected in parallel with the primary side antenna 3a. A control power supply serving as a DC variable power supply is connected to both the ends of the variable capacitor (C2) 11b through resisters R1 and R2. As the resisters R1 and R2, registers having sufficiently large resistances not to cause an AC current on the antenna side to flow into the control power supply are selected. In this case, two capacitors C1 and C3 are AC-cut capacitors to prevent a DC from the control power supply from flowing into the antenna side, and may be fixed capacitors. As the capacitors, capacitors having capacitances sufficiently larger than the capacitance of the variable capacitor (C2) 11b are selected.

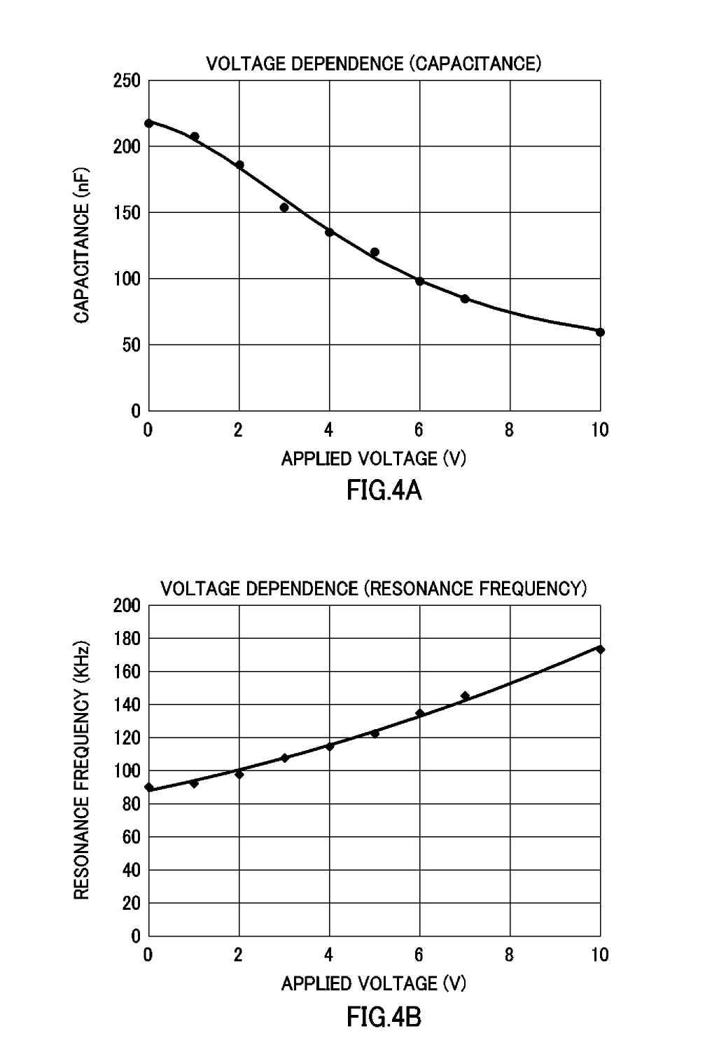

When the value of a control voltage is changed, a DC voltage applied across both the ends of the variable capacitor (C2) 11b, and, accordingly, the capacitance changes. The capacitance of the variable capacitor (C2) 11b, as shown in FIG. 4A, has a negative coefficient with respect to a DC bias voltage applied across both the ends of the variable capacitor (C2) 11b. Thus, when a DC bias voltage applied across both the ends is increased, as shown in FIG. 4B, the resonance frequency can be increased. The resonance frequency of the secondary side antenna unit 52a can also be changed like the primary side antenna unit 3a as a matter of course.

In order to change the capacitance of the resonance capacitor to change the resonance frequency of the antenna unit 3, as shown in FIG. 3B, a plurality of fixed capacitors may be connected in parallel with each other, and the fixed capacitors C4, C5, and C6 may be switched by a combination of ON/OFF states of transistor switches Tr1 and Tr2. A setting and an output of a control voltage may be performed in the control unit 5a.

The inverter unit 2 has a rectifying and smoothing circuit which receives an electric power from the commercial power supply 6 to temporarily convert the electric power into a DC, drives the primary side antenna unit 3a with, preferably, a sine wave having a drive frequency set by the control unit 5a using the converted DC. The circuit configuration of the drive unit can be arbitrarily set as a half-bridge or full-bridge configuration or the like depending on an electric power for driving the antenna unit 3a, and transistors corresponding to voltages applied or currents flowing in the antenna unit 3a may be set and combined to each other.

The waveform monitor 4 measures the current flowing in the antenna unit 3a, and, preferably holds a peak value of the current. As the measurement of the current, a voltage may be measured by a resistor inserted in series with a coil of the antenna unit 3a or may be measured by a hall element or the like. Another known means may be used. The acquired peak current value is preferably converted into a digital signal by an A/D converter, and may be stored in a storage unit 5b on the basis of an instruction of the control unit 5a. The digital signal may be temporarily stored in a storage unit included in the waveform monitor unit 4 itself. With respect to the characteristics of the resonance circuit including the antenna unit 3a obtained by the waveform monitor unit 4, the peak value of the current, an actual value, and the like can be arbitrarily set. Not only a measurement of a current value, but also acquisition of the peak value of a voltage, an actual value, or the like may be performed as a matter of course.

The control system unit 5 preferably includes the storage unit 5b in which a program expressing an operation procedure of the power transmission device 1 is written, and the control unit 5a that controls an operation of the power transmission device 1 according to the procedure in the storage unit 5b. The control unit 5a is a CPU (Central Processing Unit) or a micro-controller. The storage unit 5b may be a mask ROM mounted on, for example, a micro-controller, or may be an EPROM, an EEPROM, or the like. The storage unit 5b is not limited to these memories.

The control unit 5a configuring the control system unit 5 sets a drive frequency for driving the antenna unit 3a to the inverter unit 2 according to the program stored in the storage unit 5b. The inverter unit 2 oscillates in a sine wave having the set drive frequency to drive the antenna unit 3a. When the power receiving device 50 is in a communication area of the power transmission unit 1, a current flowing in the antenna unit 3a changes due to the presence of the resonance circuit configured by the secondary side antenna unit 52a, and the change is acquired by the waveform monitor unit 4. Alternatively, when a foreign object such as a metal is present at the position of the power receiving device 50, a peak value of the current is acquired by the waveform monitor unit 4.

In the control system unit 5, the control unit 5a changes the drive frequency according to the program stored in the storage unit 5b, and acquisition of peak values of currents in the antenna unit 3a to the changed drive frequencies is repeated predetermined times to acquire a frequency characteristics of currents flowing in the resonance circuit. The peak current values to the acquired drive frequencies are compared with each other to obtain a detection pattern. The detection pattern is compared with a detection pattern of peak current values to the presence and absence of a power receiving device set in the storage unit 5b or the like in advance to cause the control unit 5a to determine the presence and absence of the power receiving device.

2. Principle and Operation of Power Transmitting Device

A principle to determine the presence/absence of the power receiving device by the power transmission device according to an embodiment of the present invention will be described below in some cases together with the operation of the power transmission device.

2-1. Difference Between Frequency Characteristics of Antenna Currents in the Presence of Power Receiving Device and in the Presence of Foreign Object

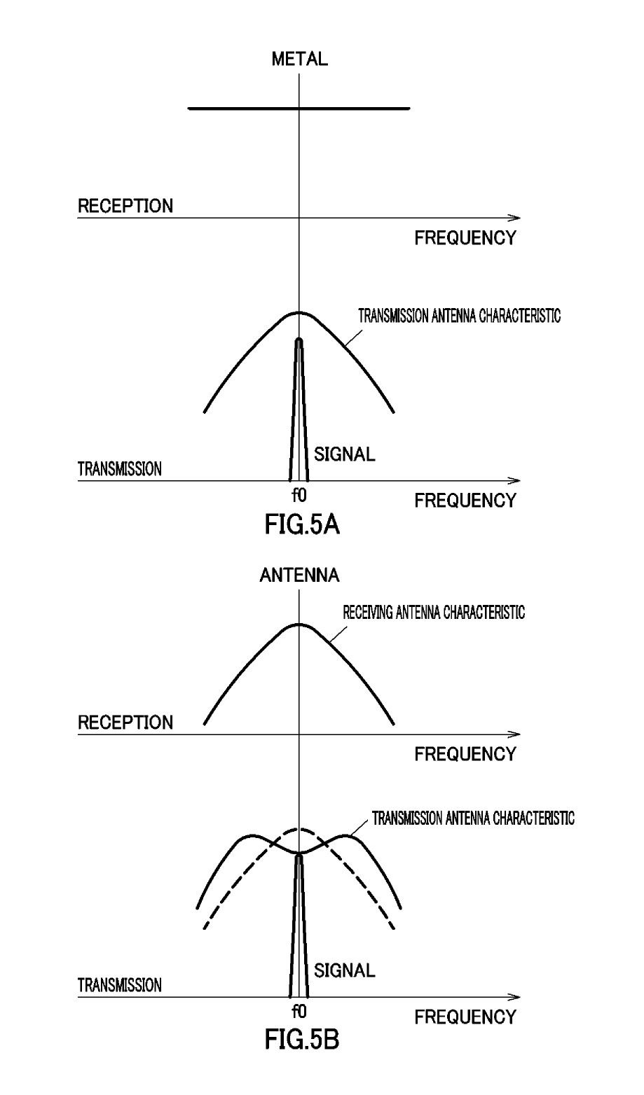

FIGS. 5A and 5B shows outlines of a frequency characteristic of a current flowing in the antenna unit 3a configurating the resonance circuit of the primary side power transmission device 1 and a frequency characteristic of a current flowing in the antenna unit 52a of the secondary side power receiving device 50 or a metal (foreign object). The upper side of the drawing shows the frequency characteristic on the power receiving side or the foreign object side, and the lower side of the drawing shows the frequency characteristic on the power transmission side.

FIG. 5A shows an outline of a frequency characteristic of a current flowing in the antenna unit 3a of the power transmission device 1 when a metal is disposed on the secondary side. In the primary side power transmission device 1, the antenna unit 3a configures a resonance circuit having the resonance frequency f0. It is assumed that the frequency characteristic of the resonance circuit exhibits a single-peaked characteristic having the resonance frequency f0 as a peak. In consideration of disposing a metal on the secondary side, since the resonance frequency of the metal is considerably higher than a drive frequency of a commonly-used noncontact communication device or a charging device or a frequency (frequency used in RFID is 13.56 MHz or the like) used as a resonance frequency, a nearly flat frequency characteristic is obtained. When such a metal is disposed on the secondary side, the primary side resonance circuit is driven at the resonance frequency f0, a characteristic according to the frequency characteristic of the primary side resonance circuit is merely acquired, i.e., the frequency characteristic itself of the antenna unit 3a is acquired.

On the other hand, as shown in FIG. 5B, a case in which a power receiving device including a resonance circuit having the same resonance frequency as the resonance frequency on the primary side is disposed on the secondary side will be considered. In this case, the frequency characteristic of the primary side resonance circuit exhibiting a single-peaked characteristic as indicated by a broken line comes to exhibit a double-peaked characteristic as indicated by a bold line. When the power receiving device 50 including a resonance circuit having the same resonance frequency as the resonance frequency of the primary side power transmission device 1 is disposed on the secondary side, a remarkable change in waveform appears in a current flowing in the primary side antenna unit 3a.

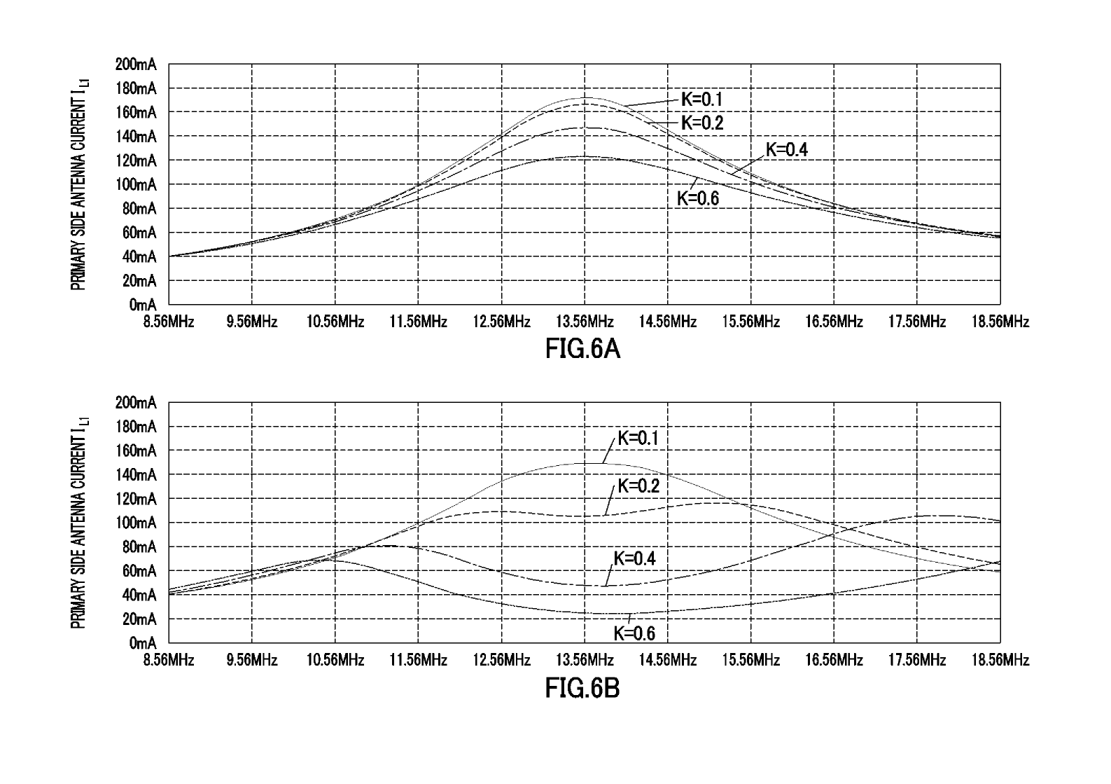

FIG. 6A is obtained by plotting actual values of frequency characteristics of a current in the primary side antenna unit 3a when a coil is disposed on the secondary side. Reference symbol K shown in FIG. 6A denotes a coupling coefficient representing a coupling strength between the primary side antenna unit 3a and the secondary side antenna unit 52a. Self-inductances of the primary side antenna unit 3a and the secondary side antenna unit 52a are represented by L1 and L2 respectively, and a mutual inductance thereof is represented by M. In this case, the following relationship is satisfied.

M=K·(L1×L2)^{0.5}

When the value K increases, the coupling strength between the primary side and the secondary side becomes strong. As shown in FIG. 6A, in comparison with the case in which K=0.1, when the coupling coefficient increases, i.e., K=0.2, 0.4, 0.6, a larger electric power is transmitted to the secondary side. For this reason, the peak of the frequency characteristic lowers.

FIG. 6B is obtained by plotting actual values of frequency characteristics of currents in the primary side antenna unit 3a when a resonance circuit having the same resonance frequency as that on the primary side is disposed on the secondary side. K=0.2 or more shows that the frequency characteristic of the current exhibits a double-peaked characteristic having two peaks.

In this manner, when it is determined whether the frequency characteristic of a current flowing in the primary side resonance circuit is a single-peaked characteristic or a double-peaked characteristic, it can be detected whether the power receiving device is disposed on the secondary side or a metal or the like except for the power receiving device is disposed.

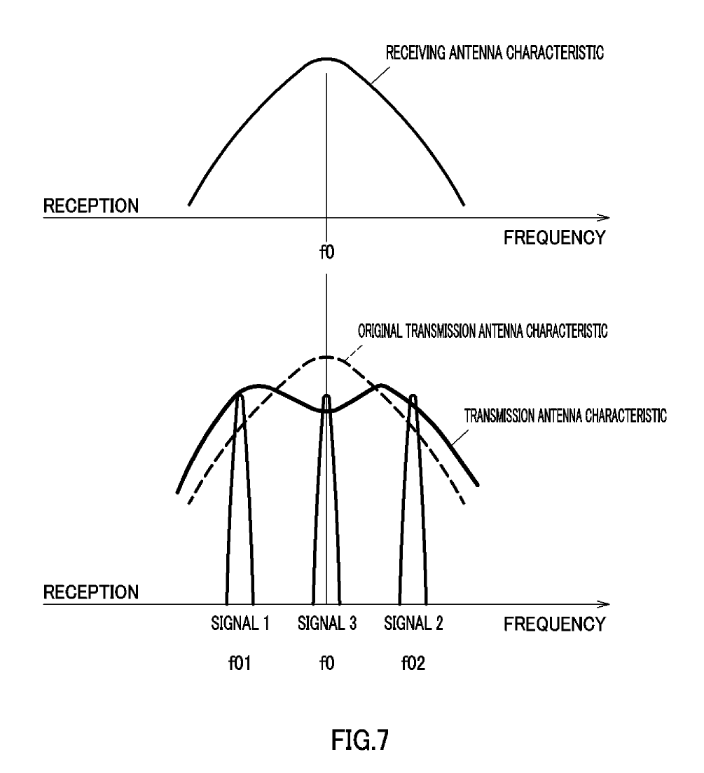

More specifically, in order to acquire a frequency characteristic of a current flowing in the resonance circuit, as shown in FIG. 7, the resonance circuit is driven by a signal 1 having the frequency f01 lower than the resonance frequency f0 of the resonance circuit by Δf (such a frequency is called a drive frequency). The resonance circuit is driven by a signal 2 having the drive frequency f02 higher than the resonance frequency f0 by Δf. In this manner, as indicated by a bold line on the lower side in FIG. 7, in comparison with a current value at the resonance frequency f0, the drive frequencies f01 and f02 are appropriately selected to make it possible to determine whether the frequency characteristic of the resonance circuit is a double-peaked characteristic. The number of set values of a drive frequency to acquire a current value may be increased, or the drive frequency may be changed in an analog manner to acquire a current value corresponding to the drive frequency, as a matter of course.

2-2. Detection of Difference Between Frequency Characteristics of Antenna Current in Weak Coupling

As described above, a frequency characteristic of a current flowing in the antenna unit 3a configuring the primary side resonance circuit is measured to determine whether the frequency characteristic has one peak (single-peaked characteristic) or two peaks (double-peaked characteristic), so that the presence and absence of a power receiving device can be detected. However, as shown in FIG. 6B, when the coupling between the primary side and the secondary side is weak (K=0.1), even though the power receiving device is disposed on the secondary side, no double-peaked characteristic appears, and a difference between the power receiving device and a foreign object such as a metal except for the power receiving device cannot be detected.

Resonance conditions on the primary side are changed to change resonance frequencies of resonance circuits. Frequency characteristics of currents flowing in the resonance circuits having resonance frequencies are acquired. In this manner, when the resonance circuit of the secondary side power receiving device 50 has a resonance frequency equal to the original resonance frequency f0 on the primary side, even though the coupling is weak, electric power transmission is performed at about the resonance frequency f0. A current flowing in the primary side resonance circuit is smaller than a current value obtained at another frequency.

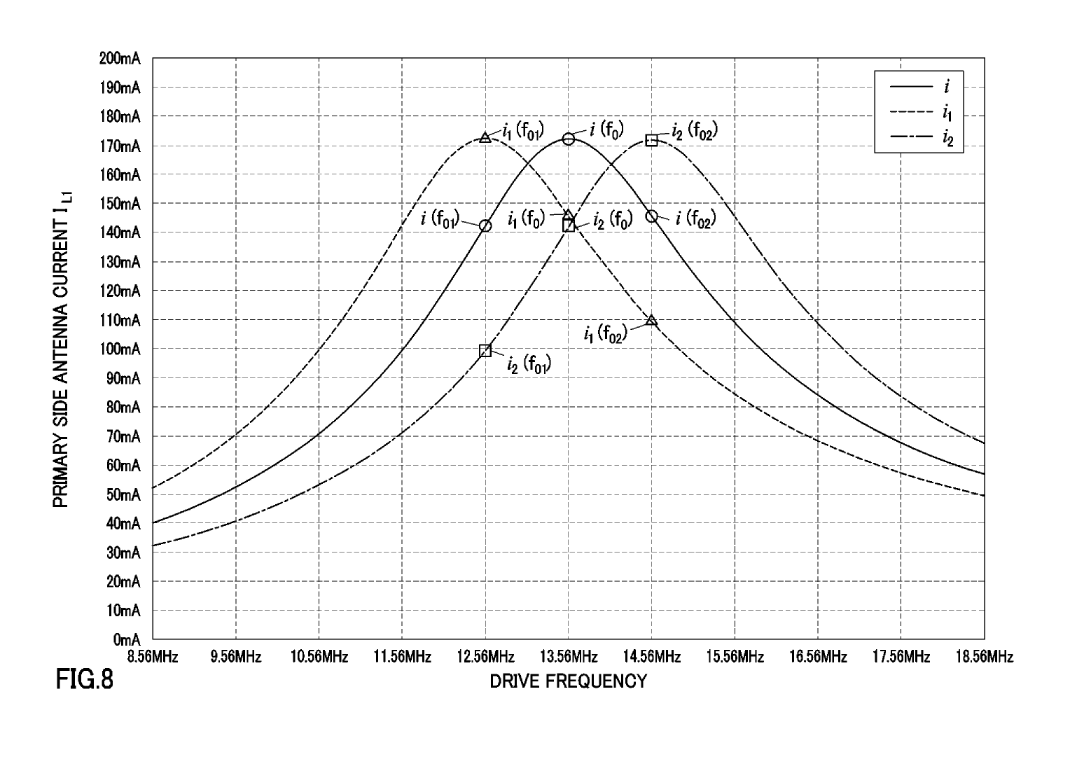

FIG. 8 shows a graph obtained by plotting actual values of frequency characteristics of currents flowing in the primary side antenna unit 3a when a coil is disposed on the secondary side and the coupling coefficient K=0.1. In this case, it is assumed that the coil on the secondary side does not configure a resonance circuit. The resonance frequency f0 of the resonance circuit including the antenna unit 3a is set to 13.56 MHz generally used in RFID. A graph indicated by a solid line in FIG. 8 represents a frequency characteristic of a current i flowing in the resonance circuit having the resonance frequency f0 (=13.56 MHz). A graph indicated by a broken line represents a frequency characteristic of a current i1 flowing in a resonance circuit having the resonance frequency f01 (=12.56 MHz) lower than f0 by Δf (=1 MHz). A graph indicated by a chain line represents a frequency characteristic of a current i2 flowing in a resonance circuit having the resonance frequency f02 (=14.56 MHz) higher than f0 by Δf. A frequency to be set may be set depending on frequency characteristics of resonance circuits to be used. The frequency may be arbitrarily set according to applications to 120 kHz or the like used in a noncontact power transmission system as a matter of course.

In the frequency characteristic of the current i flowing in the resonance circuit having the resonance frequency f0, the current i (f0) comes to close to the maximum value when the frequency is f0. Thus, a magnitude relation between i1 (f0), a current i (f01) obtained when the frequency is f01, and a current i (f02) obtained when the frequency is f02 is given by:

i(f0)>i(f01),i(f02) (1)

In the frequency characteristic of the current i1 flowing in the resonance circuit having the resonance frequency f01, the current i1 (f01) comes close to the maximum value when the frequency is f01. Thus, a magnitude relation between i1 (f0), i1 (f01), and i1 (f02) is given by:

i1(f01)>i1(f01)>i1(f02) (2)

Similarly, in the frequency characteristic of the current i2 flowing in the resonance circuit having the resonance frequency f02, the current i2 (f02) comes close to the maximum value when the frequency is f02. Thus, a magnitude relation between i2 (f0), i2 (f01), and i2 (f02) is given by:

i2(f01)<i2(f0)<i2(f02) (3)

Since the circuit on the secondary side has no frequency characteristic, the maximum values of the currents in above three frequency characteristics are almost equal to each other.

i(f0)≈i1(f01)≈i2(f02) (4)

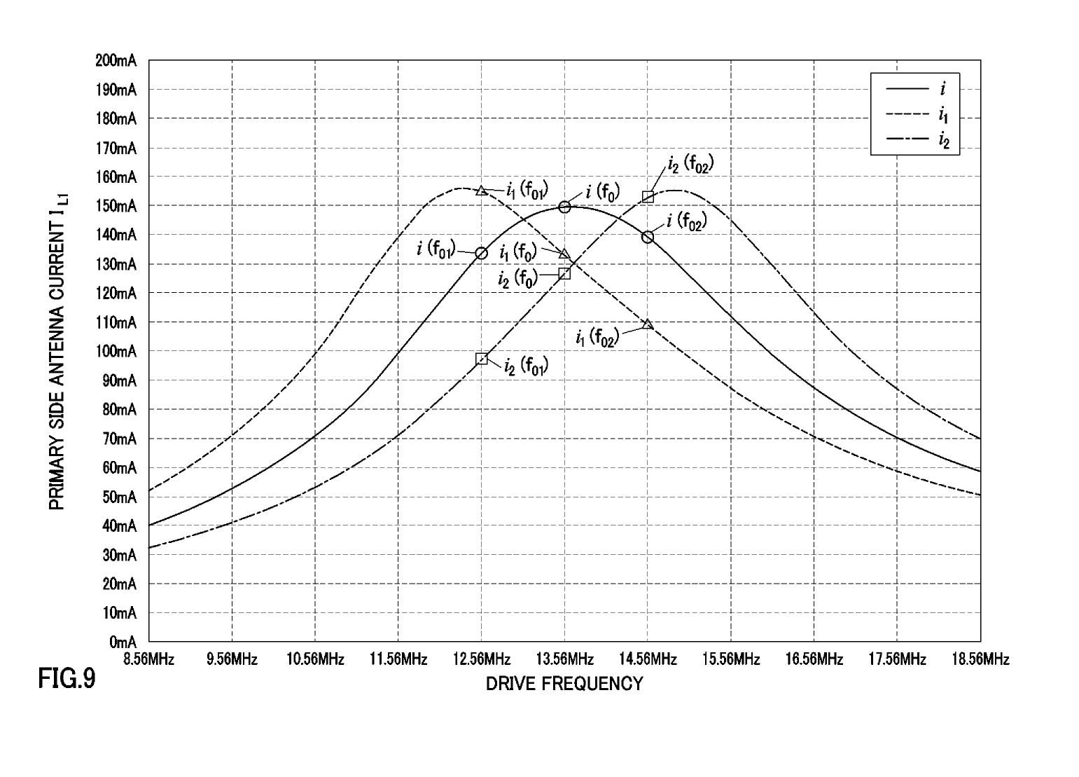

FIG. 9 shows a graph obtained by plotting actual values of frequency characteristics of currents flowing in the primary side antenna unit 3a when a resonance circuit having a resonance frequency equal to the resonance frequency f0 on the primary side is disposed on the secondary side. The resonance frequency f0 of the resonance circuit including the antenna unit 3a is set to, as in the case in FIG. 8, 13.56 MHz generally used in RFID. A graph indicated by a solid line in FIG. 9 represents a frequency characteristic of the current i flowing in the resonance circuit having the resonance frequency f0 (=13.56 MHz). A graph indicated by a broken line is a frequency characteristic of the current i1 flowing in the resonance circuit having the resonance frequency f01 (=12.56 MHz) lower than f0 by Δf (=1 MHz). A graph indicated by a chain line represents a frequency characteristic of the current i2 flowing in the resonance circuit having the resonance frequency f02 (=14.56 MHz) higher than f0 by Δf.

In the frequency characteristic of the current i flowing in the resonance circuit having the resonance frequency f0, the same result as that in the case in FIG. 8 is obtained. More specifically, a magnitude relation between the current i (f01) at the frequency f01 and the current i (f02) at the frequency f02 is the relationship given by the above expression (1).

Similarly, with respect to the frequency characteristic of the current i1 flowing in the resonance circuit having the resonance frequency f01, a magnitude relation between the current values i1 (f0), i1 (f01), and i1 (f02) at the frequencies f0, f01, and f02 respectively is the relation given by the expression (2).

Also with respect to the frequency characteristic of the current i2 flowing in the resonance circuit having the resonance frequency f02, a magnitude relation between the current values i2 (f0), i2 (f01), and i2 (f02) at the frequencies f0, f01, and f02 respectively is the relation given by the expression (3).

On the other hand, a magnitude relation between the peak values i (f0), i1 (f01), and i2 (f02) of the currents at the respective frequencies is given by:

i(f0)<i1(f01),i2(f02) (5)

Since the resonance frequency f0 of the secondary side resonance circuit is equal to the resonance frequency f0 of the primary side resonance circuit, the peak value of the current in the primary side resonance circuit decreases because electric power transmission is performed from the primary side to the secondary side at the frequency f0 to show that the peak value of the current increases when the frequency is deviated from the resonance frequency f0 on the secondary side.

As described above, three drive frequencies are set for the resonance circuits having three different resonance frequencies to acquire frequency characteristics. When the maximum values of the currents in the resonance circuits are not changed, it can be determined that a foreign object such as a metal is disposed on the secondary side without disposing the power receiving device 50 on the secondary side.

2-3. Deviation of Resonance Frequency on Power Receiving Device Side

Although a noncontact IC card may be disposed on the secondary side (power receiving device side), a noncontact IC card may be placed on an IC card or the like having a communication format different from that of the noncontact IC card, and may be frequently carried together with a metal object which shields a magnetic field. In consideration of this, the resonance frequency of the resonance circuit is set to a higher value in many cases.

As described above, when the resonance frequency of the secondary side resonance circuit is equal to the resonance frequency on the primary side, electric power transmission occurs. For this reason, when coupling between the primary side and the secondary side is strong (for example, K is 0.2 or more), the frequency characteristic of a current flowing in the primary side resonance circuit is considerably different from that obtained when a foreign object such as a simple metal is disposed. Even though the coupling between the primary side and the secondary side is weak to obtain a small coupling coefficient (for example, K is about 0.1), the resonance frequency of the primary side resonance circuit is made different from the original resonance frequency to acquire a frequency characteristic of the current, so that a difference between the frequency characteristic and the frequency characteristic obtained when the foreign object is disposed.

Furthermore, in the present invention, even though a noncontact IC card having a resonance frequency which is set to a higher value due to the above circumstances is disposed on the secondary side, a difference between the frequency characteristic and the frequency characteristic obtained when the foreign object such as a metal is disposed is generated to make it possible to achieve the detection.

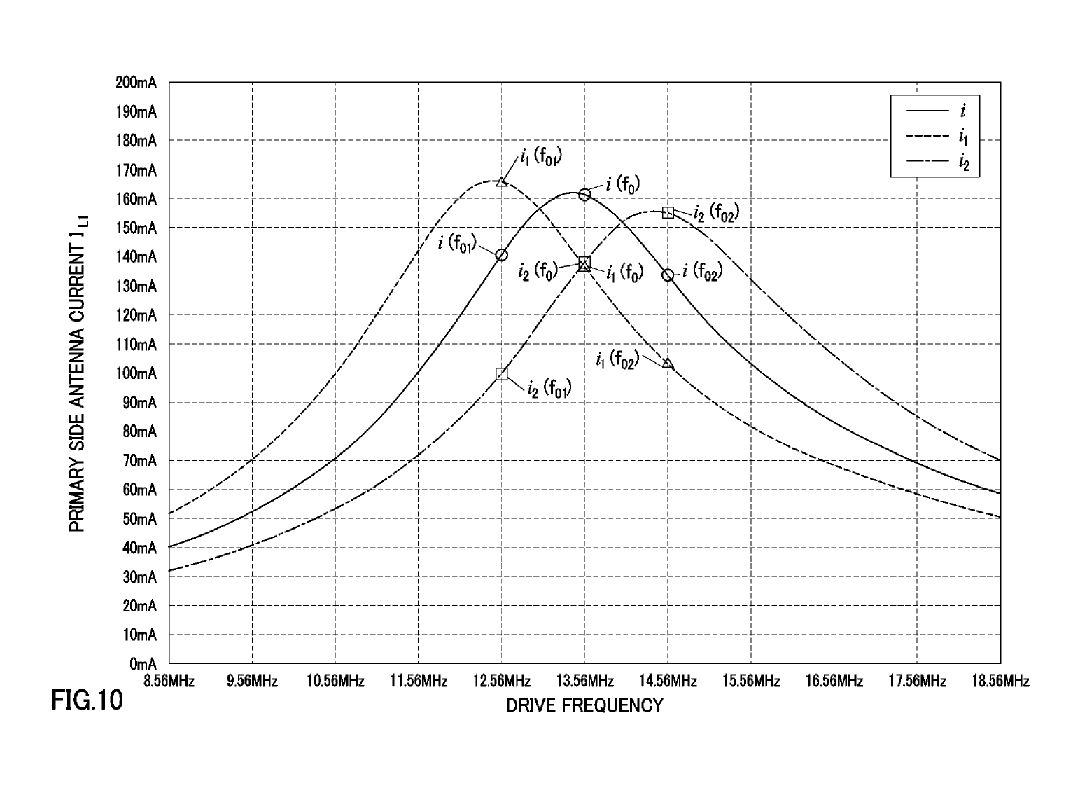

The secondary side resonance frequency was set to 16 MHz, the primary side resonance frequency was set to 13.56 MHz as in the cases in FIGS. 8 and 9, and a frequency characteristic of a current flowing in the primary side resonance circuit was measured. As shown in FIG. 10, in the frequency characteristic of the current i flowing in the resonance circuit having the resonance frequency f0, the same tendency as that in the case in FIG. 8 is obtained. More specifically, a magnitude relation between i (f0), the current i (f01) at the frequency f01 and the current i (f02) at the frequency f02 is the relation given by the above expression (1).

With respect to the frequency characteristic of the current i1 flowing in the resonance circuit having the resonance frequency f01, a magnitude relation between the current values i1 (f0), i1 (f01), and i1 (f02) at the frequencies f0, f01, and f02 respectively is the relation given by the above expression (2).

Also with respect to the frequency characteristic of the current i2 flowing in the resonance circuit having the resonance frequency f02, a magnitude relation between the current values i2 (f0), i2 (f01), and i2 (f02) at the frequencies f0, f01, and f02 respectively is the relation given by the expression (3).

On the other hand, a magnitude relation between the maximum values i (f0), i1 (f01), and i2 (f02) of the currents at the respective frequencies is given by:

I1(f01)>i(f0)>i2(f02) (6)

Since the frequencies f01, f0, and f02 are lower than a resonance frequency f0′ on the secondary side, it is shown that the coupling strengths between the primary side and the secondary side increase in the order of the magnitude relation given by expression (6) and the peak value of the current on the primary side tends to lower.

When the resonance frequency of the device or apparatus on the secondary side is set to a frequency relatively lower than the resonance frequency on the primary side, as in the case described above, the coupling strengths between the primary side and the secondary side decrease in the order of the magnitude relation given by expression (6). For this reason, the peak value of the current on the primary side tends to increase.

2-4. Detection of Difference Between Frequency Characteristics of Antenna Currents when Coupling Coefficient Changes

In consideration of utility forms of a noncontact communication module mounted to achieve a noncontact IC card or the functions of the noncontact IC card with a mobile phone or the like, distances between these devices or apparatuses and a power transmission device or a transmission device such as a reader/writer may change with time. In general, since coupling is often performed while a noncontact IC card or the like is brought close to the reader/writer. At this time, since the distance between the primary side and the secondary side is shortened with time, the coupling coefficient increases with time.

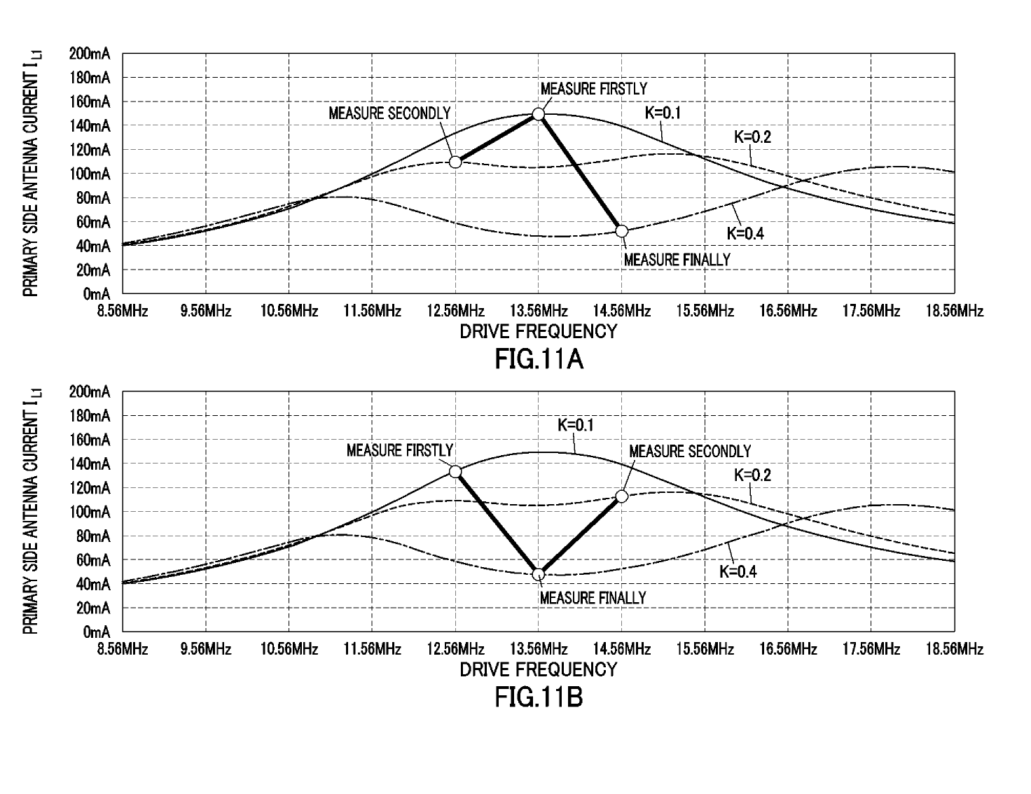

As shown in FIG. 11A and FIG. 11B, the coupling coefficient K increases with time, frequency characteristics of currents flowing in the primary side resonance circuit change with time in the order of a slid line graph, a broken like graph, and a chain line graph.

In detection of a difference between frequency characteristics described in 2-1, 2-2, and the like with respect to the coupling coefficients changed as described above, an order (order of measurements) of settings of frequencies corresponding to current values to be measured must be noted.

As shown in FIG. 11A, when current values at frequencies at which the current values are to be measured are measured in an order of frequencies, i.e., the resonance frequency f0 (=13.56 MHz) of the primary side resonance circuit, the frequency f01 (=12.56 MHz) lower than f0 by Δf, and the frequency f02 (=14.56 MHz) higher than f0 by Δf, the coupling strengths between the primary side and the secondary side gradually increase. For this reason, the current values have the following relation. When the relation is expressed as i=i (f0x, K) where the current value i is a function of the frequency f0x and the coupling coefficient K, the above relation can be expressed as follows.

i(f0,K=0.1)>i(f01,K=0.2)>i(f02,K=0.4) (7)

Since a magnitude relation between i (f01, K=0.2) and i (f02, K=0.4) is given by i (f02, K=0.2)>i (f01, K=0.4) when the frequency f02 is measured first, in general, the following expression is obtained.

i(f0,K=0.1)>i(f0x,K>0.1)(x=1 or 2) (7′)

As indicated by a broken line graph and a chain line graph in FIG. 11A, although a power receiving device or apparatus is disposed on the secondary side, a frequency characteristic of a current is not substantially a double-peaked characteristic, and erroneous detection occurs.

Thus, when the current value at the primary side resonance frequency f0 is measured at the last, the frequency characteristic of the current value in the primary side resonance circuit can be detected.

As shown in FIG. 11B, when the current values are measured in the order of the frequency f01 lower than the primary side resonance frequency f0 by Δf, the frequency f02 higher than the primary side resonance frequency f0 by Δf, and the primary side resonance frequency f0, the expression (5) described above is satisfied. The device or apparatus on the secondary side can be detected.

2-5. Setting of Detection Pattern

By using the principle described above, a magnitude relation between frequencies of current values in the primary resonance circuit is patterned to make it possible to determine the presence and absence of a device or apparatus on the secondary side.

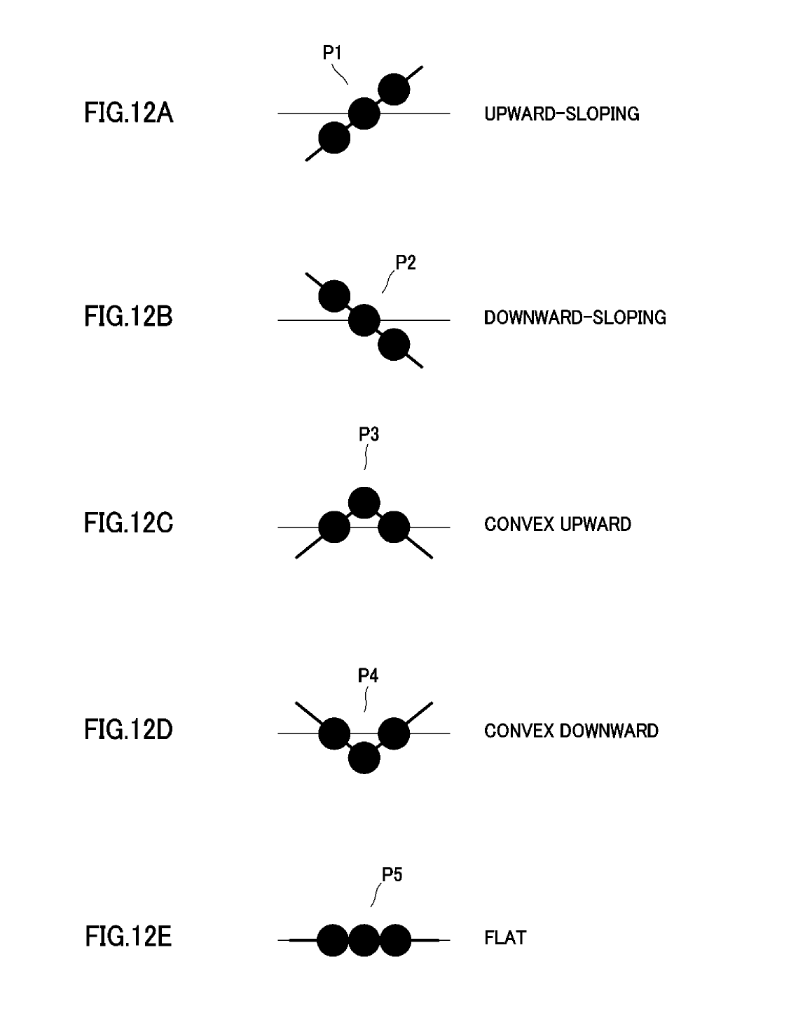

FIG. 12A to FIG. 12E show patterns of magnitude relations of current values when current values at a resonance frequency and drive frequencies before and after the resonance frequency when a frequency characteristic of a current flowing in the resonance circuit in which one resonance frequency is set is acquired. A black circle represents a current value corresponding to the drive frequency. All FIG. 12A to FIG. 12E show a magnitude relation between current values measured at the three frequencies. The measurement frequencies are represented by f01, f0, and f02 ordered from the left. FIG. 12A shows an upward-sloping tendency (pattern P1). In FIG. 12B, a pattern P2 having a downward-sloping tendency is set. In FIG. 12C, a pattern P3 having a convex-upward tendency is set, and, in FIG. 12D, a pattern P4 having a convex-downward tendency is set. FIG. 12E shows a flat pattern P5.

As described in 2-1, when a foreign object such as a metal is disposed on the secondary side, since the foreign object does not have a frequency characteristic, the pattern P5 having a flat tendency as shown in FIG. 12E is obtained when the frequency characteristic of the current in the primary side resonance circuit is measured (expression (4)).

When a power receiving device or apparatus having a resonance circuit having the resonance frequency f0 equal to the resonance frequency f0 of the primary side resonance circuit is disposed on the secondary side, the pattern P4 having a convex-downward tendency as shown in FIG. 12D is shown (expression (5)).

When the number of frequencies at which current values are acquired is increased or changed in an analog manner to acquire frequency characteristics of the current values in an analog manner, more detailed pattern setting can be achieved as a matter of course.

When a coupling strength is relatively high, i.e., when the coupling coefficient K is about 0.2 or more, the patterns P4 and P5 of the two types described above are detected to make it possible to detect a power receiving device or apparatus or a foreign object. However, when the coupling strength is low, i.e., the coupling coefficient K is lower than 0.2, the system must be further devised. As described in 2-2 and 2-3 described above, the resonance frequency of the primary side resonance circuit is changed, currents flowing in the resonance circuit having different resonance frequencies must be measured and patterned. Since patterning is performed by further combining the patterns in FIG. 12A to 12E, it is assumed that the pattern is conveniently called a weak coupling detection pattern.

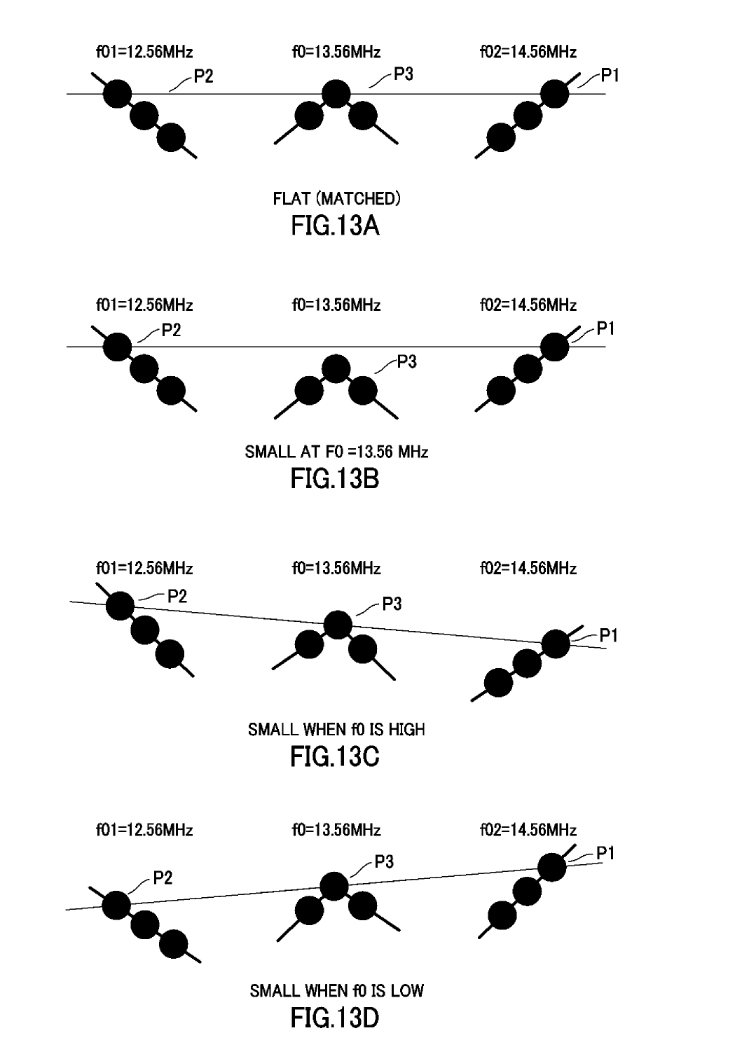

FIG. 13A to FIG. 13D show weak coupling detection patterns obtained by combining tendencies of frequency characteristics of current flowing in the resonance circuit while the three resonance frequencies of the resonance circuit are changed. Each of FIG. 13A to 13D is constituted by three patterns. The patterns are the patterns P1 to P5 shown in FIG. 12A to FIG. 12E, respectively. More specifically, the three patterns include a pattern having a frequency characteristic of the current i1 flowing in the resonance circuit set to the resonance frequency f01 lower than the resonance frequency f0 of the primary side resonance circuit by Δf, a pattern having a frequency characteristic of the current i flowing in the resonance circuit set to the primary side resonance frequency f0, and a pattern having a frequency characteristic of the current i2 flowing in the resonance circuit set to the resonance frequency f02 higher than the resonance frequency f0 of the primary side resonance circuit by Δf. In general, as shown in the drawings, the frequency characteristic of the current flowing in the resonance circuit having the resonance frequency f01 shows the downward-sloping pattern P2 as shown in FIG. 12B (expression (2)). The frequency characteristic of the current flowing in the resonance circuit having the resonance frequency f0 shows the convex-upward pattern P3 as shown in FIG. 12C (expression (1)). The frequency characteristic of the current flowing in the resonance circuit having the resonance frequency f02 shows an upward-sloping pattern P1 as shown in FIG. 12A (expression (3)). The maximum values of the currents in the patterns of the three types are compared with each other to make it possible to detect a power receiving device or apparatus or a foreign object as an object disposed on the secondary side.

FIG. 13A shows a case in which the maximum values of the patterns P2, P3, and P1 of the three types are almost equal to each other, and shows a weak coupling detection pattern obtained when a foreign object such as a metal is disposed on the secondary side. FIG. 13B shows a weak coupling detection pattern in which, of the maximum values of the patterns P2, P3, and P1 of the three types, the maximum value of the frequency characteristic of a current flowing in the resonance circuit set to the resonance frequency f0 is lower than other maximum values, and shows a tendency obtained when a power receiving device or apparatus is disposed on the secondary side. FIG. 13C shows a weak coupling detection pattern in which, when the maximum values of the patterns P2, P3, and P1 of the three types have downward-sloping tendencies, the resonance frequency of the power receiving device or apparatus on the secondary side is higher than each of all the resonance frequencies on the primary side. FIG. 13D shows a weak coupling detection pattern in which, when the maximum values of the patterns P2, P3, and P1 of the three types have upward-sloping tendencies, the resonance frequency of the power receiving device or apparatus on the secondary side is lower than each of all the resonance frequencies on the primary side.

As described above, when combinations between the patterns P1 to P5 showing the tendencies of the frequency characteristics of the currents flowing in the resonance circuit and patterns obtained when the resonance frequencies of the primary side resonance circuit are changed are set as weak coupling detection patterns, it can be detected independently of coupling coefficients whether a power receiving device or apparatus is disposed on the secondary side.

3.3. Method for Detecting Power Receiving Device

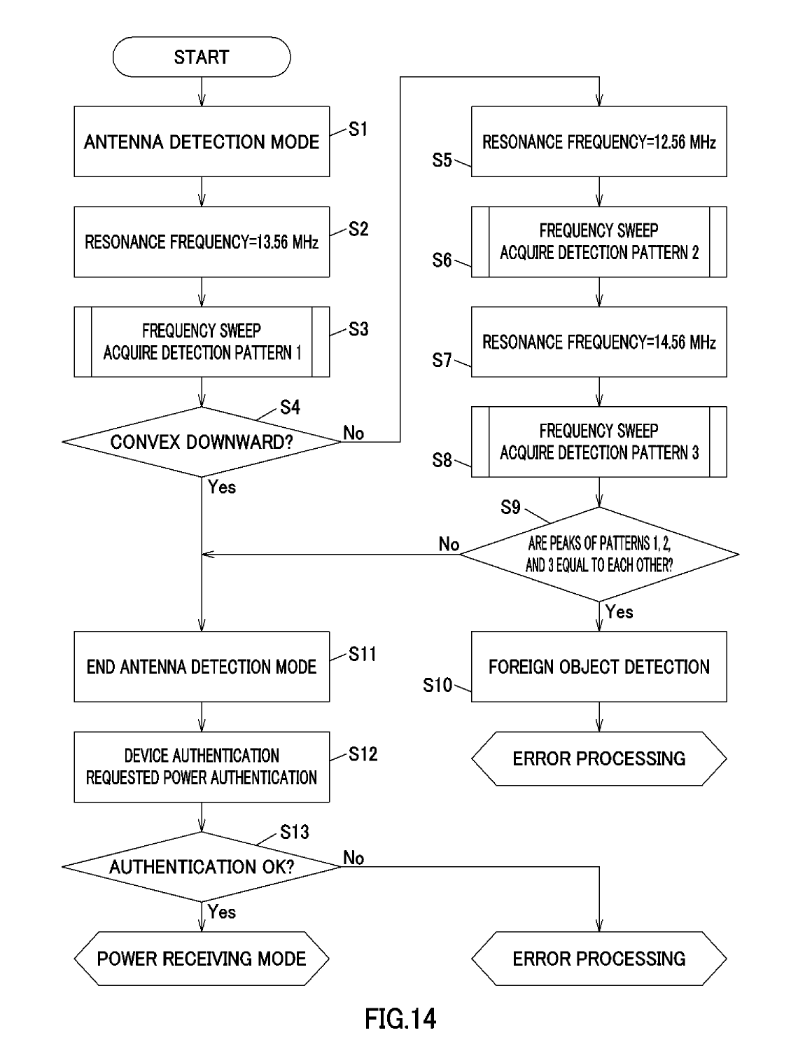

FIG. 14 shows a flow chart of a method for detecting power receiving device according to one embodiment of the present invention.

The control unit 5a of the power transmission device 1, in step S1, sets the power transmission device 1 in an antenna detection mode. In the antenna detection mode, an electric power is not transmitted from the power transmission device 1 to the power receiving device 50 (or a foreign object such as a metal), and an operation to detect the presence and absence of the power receiving device on the secondary side is performed as described below. In a detection period for the secondary side power receiving device, a normal electric power is transmitted from the primary side when a foreign object such as a metal is present, the metal generates heat. For this reason, an antenna detection mode for performing detection on the secondary side is preferably set after the transmission of the electric power is stopped. Since the antenna detection mode which executes short-time polling, the antenna detection mode is preferably intermittently executed.

The control unit 5a, in step S2, sets the resonance frequency f0 (for example, f0=13.56 MHz) to the transmission and receiving unit 3 configuring the resonance circuit.

The control unit 5a sets a drive frequency to f01 (for example, f01=12.56 MHz) lower than the resonance frequency f0 by Δf, and acquires a current value at the frequency f01. The drive frequency is set to f02 (for example, f02=14.56 MHz) higher than the resonance frequency by Δf, and a current value at the frequency f02 is acquired. Furthermore, a current value obtained when the drive frequency is f0 is acquired. The acquired current value is preferably stored in the storage unit 5b as a detection pattern 1 in association with the drive frequency. The control unit 5a determines whether the detection pattern 1 corresponds to any one of the patterns P1 to P5 in FIG. 12A to FIG. 12E, and stores the pattern 1 in the storage unit 5b in association with the corresponding pattern.

The control unit 5a determines, in step S4, whether the acquired pattern 1 is matched with the convex-downward pattern P4 (FIG. 12D) of the patterns in FIG. 12A to FIG. 12E. When the pattern 1 is matched with the convex-downward pattern P4, the control unit 5a ends the antenna detection mode (step S11), authenticates whether the power receiving device or apparatus is valid as an object for electric charging or communication (step S12 and step S13). When the power receiving device or apparatus can be authenticated, the control unit 5a shifts to a power receiving mode to start electric charging or starts communication. When the power receiving device or apparatus cannot be authenticated, the control unit 5a performs error processing.

The control unit 5a, when the power receiving device or apparatus cannot be detected in step S4, changes a constant of the primary side resonance circuit and changes the resonance frequency into f01. With respect to the resonance frequency f01, as in step S3, current values are acquired in units of drive frequencies, and a detection pattern 2 obtained by associating the current values with the drive frequencies is acquired. One of FIG. 12A to FIG. 12E into which the detection pattern 2 is classified is also stored in the storage unit 5b in association with the detection pattern 2.

Furthermore, the control unit 5a, in step S7, changes the resonance frequency of the resonance circuit into f02, as in steps S3 and S6, and acquires frequency characteristics of currents flowing in the resonance circuit having the resonance frequency f02 as current values in units of drive frequencies. A detection pattern 3 obtained by associating the current values and the drive frequencies is acquired. One of FIG. 12A to FIG. 12E into which the detection pattern 3 is classified is also stored in the storage unit 5b in association with the detection pattern 3.

The control unit 5a, in step S9, compares the maximum values of the current values of the detection pattern 1 to the detection pattern 3. When all the maximum values are equal to each other, the control unit 5a determines in step S10 that a foreign object is detected, and performs error processing. When all the maximum values of the current values of the detection patterns are not equal to each other, the control unit 5a determines that a power receiving device or apparatus is disposed, ends the antenna detection mode (step S11), and performs device authentication (step S12).

In steps S3, S6, and S8, on the assumption that a distant power receiving device or apparatus gradually comes close to the system, as described in 2-4, current measurement at the resonance frequencies of the resonance circuits may be performed at the last.

The flow chart described above may be stored in the storage unit 5b as a program and processed in the control unit 5a according to the steps. Furthermore, the control unit 5a and/or the storage unit 5b may be incorporated in a semiconductor device, or may be achieved with a system using a general-purpose CPU, as a matter of course.

4. Configuration of Power Transmission and Receiving Device

As another embodiment, a device which receives an electric power transmission from a noncontact charging device or a noncontact communication device (reader/writer or the like) serving as the power transmission device 1 or transmitted data, charges its own secondary battery, and operates the main body may serve as a power transmission device for anther power receiving device. It is assumed that such a device is called a power transmission and receiving device here.

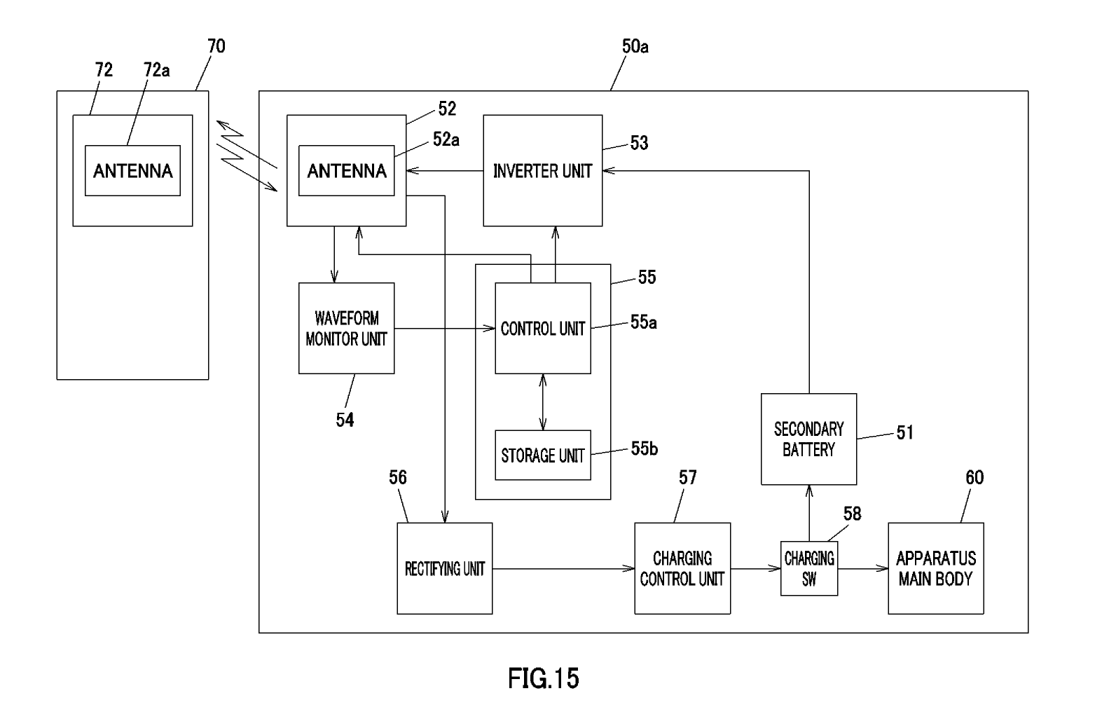

As shown in FIG. 15, a power transmission and receiving device 50a has the same configuration as that of the power transmission device 1 as described above. The same reference symbols as in the power transmission device 1 denote parts having the same functions in the power transmission and receiving device 50a.

The power transmission and receiving device 50a includes a transmission and receiving unit 52 having antenna 52a electromagnetically coupled to an antenna 72a included in another power receiving device or a power transmission and receiving device 70. The power transmission and receiving device 50a includes an inverter unit 53 that converts an electric power of a secondary battery 51 included in the power transmission and receiving device 50a into an AC electric power having a predetermined drive frequency to drive the antenna 52a of the transmission and receiving unit 52. The power transmission and receiving device 50a includes a waveform monitor unit 54 that acquires a current waveform of the antenna 52a, and a control system unit 55 that sets a drive frequency for the inverter unit 53 on the basis of a current value acquired by the waveform monitor unit 54. The control system unit 55 includes a storage unit 55b in which a program expressing an operation procedure of the power transmission and receiving device 50a is written, and a control unit 55a that controls an operation of the power transmission and receiving device 50a according to the procedure in the storage unit 55b. The control unit 55a is, for example, a CPU (Central Processing Unit) or a micro-controller. The storage unit 55b may be a mask ROM mounted on, for example, a micro-controller, or may be an EPROM, an EEPROM, or the like. The storage unit 55b is not limited to these memories.

The control unit 55a sets a drive frequency for driving the antenna unit 52a to the inverter unit 53 according to the program stored in the storage unit 55b. The inverter unit 53 oscillates in a sine wave having the set drive frequency to drive the antenna unit 52a. When the other power transmission and receiving device 70 is in a communication area of the power transmission and receiving device 50, a current flowing in the antenna unit 52a changes due to the presence of the resonance circuit configured by the antenna unit 72a, and the change is acquired by the waveform monitor unit 54. Alternatively, when a foreign object such as metal plate is present at the position of the other power transmission and receiving device 70, a peak value of the current value is acquired by the waveform monitor unit 54.

The drive frequency is changed according to the program stored in the storage unit 55b, and acquisition of peak values of currents in the antenna unit 52a to the changed drive frequencies is repeated predetermined times. A pattern obtained by comparing peak current values in units of the acquired drive frequencies is compared with a pattern of peak current values which are acquired in advance with respect to the presence/absence of the other power transmission and receiving device 70 to determine the presence/absence of the other power transmission and receiving device 70 in the control unit 55a.

The above configuration is a configuration about the power transmission function of the power transmission and receiving device 50a. The power transmission and receiving device 50a further includes a rectifying unit 56 that converts a power received through the antenna 52a into a DC power, and a charging control unit 57 that performs charging control of the secondary battery 51 by using an electric power converted into a DC power by the rectifying unit 56. The received electric power electrically charges the secondary battery 51 through the charging control unit 57, and may also directly operate a device main body 60 by a charging SW 58.

As described above, in the power transmission and receiving device 50a, by using an electric power of the secondary battery 51 included in the power transmission and receiving device 50a, operates the inverter unit 53 to make it possible to detect a power receiving device or the other power transmission and receiving device 70.

### REFERENCE SYMBOLS

1 . . . power transmission device, 2 . . . inverter unit, 3 . . . transmission and receiving unit, 3a . . . antenna unit, 3b, 11b . . . variable capacitor, 4 . . . waveform monitor unit, 5 . . . control system unit, 5a . . . control unit, 5b . . . storage unit, 50 . . . power receiving device, 50a . . . power transmission and receiving device, 51 . . . secondary battery, 52 . . . transmission and receiving unit, 52a . . . antenna unit, 53 . . . inverter unit, 54 . . . waveform monitor unit, 55 . . . control system unit, 55a . . . control unit, 55b . . . storage unit, 56 . . . rectifying unit, 57 . . . charging control unit, 58 . . . charging SW, 60 . . . apparatus main body, 70 . . . another power transmission and receiving device

1. A power transmission device which transmits an electric power to a power receiving device in a noncontact state by using a resonance circuit, comprising:
a control unit that sets a drive frequency of a signal for driving the resonance circuit;
a drive unit that drives the resonance circuit at three or more drive frequencies on the basis of a setting of the control unit; and
a drive waveform detecting unit that detects a drive waveform of the resonance circuit, wherein
the control unit sets the three or more drive frequencies, compares signal data at the drive frequencies detected by the drive waveform detecting unit with each other, and detects the power receiving device on the basis of the comparison result.

2. The power transmission device according to claim 1, wherein
the control unit includes
a power transmission mode that transmits an electric power on the basis of a request from the power receiving device, and
a detection mode that detects the presence/absence of the power receiving device, and
in the detection mode, the electric power is not transmitted.

3. The power transmission device according to claim 1, wherein
the detected signal data is a current value or a voltage value of the resonance circuit.

4. The power transmission device according to claim 1, wherein
the control unit sets a plurality of resonance frequencies of the resonance circuit, and
the resonance frequencies are set to correspond to the three or more drive frequencies, respectively.

5. The power transmission device according to claim 4, wherein
the control unit compares the maximum values of the currents or the voltages at the resonance frequencies with each other to detect the power receiving device.

6. The power transmission device according to claim 1, wherein
the control unit sequentially sets three frequencies as the drive frequencies and measures the signal data,
a first drive frequency is a frequency higher than a second drive frequency and lower than a third drive frequency,
the first drive frequency is set after the second and third drive frequencies are set and the signal data is measured, and the corresponding signal data is measured.

7. (canceled)

8. (canceled)

9. The power transmission and receiving device according to claim 27, wherein
the detected signal data is a current value or a voltage value of the resonance circuit.

10. The power transmission and receiving device according to claim 27 wherein
the control unit sets a plurality of resonance frequencies of the resonance circuit, and
the resonance frequencies are set to correspond to the three or more drive frequencies, respectively.

11. The power transmission and receiving device according to claim 10, wherein
the control unit compares the maximum values of the currents or the voltages at the resonance frequencies with each other to detect the power receiving device.

12. The power transmission and receiving device according to claim 27 wherein
the control unit sequentially sets three frequencies as the drive frequencies and measures the signal data,
a first drive frequency is a frequency higher than a second drive frequency and lower than a third drive frequency,
the first drive frequency is set after the second and third drive frequencies are set and the signal data is measured, and the corresponding signal data is measured.

13. A method for detecting power receiving device that detects, when an electric power is transmitted from a power transmission device to a power receiving device in a noncontact state by using a resonance circuit, the presence/absence of the power receiving device,
a control unit sets a drive frequency of a signal for driving the resonance circuit,
a drive unit, on the basis of a setting of the control unit, drives the resonance circuit at three or more drive frequencies,
a drive waveform detecting unit detects a drive waveform of the resonance circuit, and
the control unit sets three or more drive frequencies, compares signal data at the drive frequencies detected by the drive waveform detecting unit with each other, and detects the power receiving device on the basis of the comparison result.

14. The method for detecting power receiving device according to claim 13, wherein
the control unit includes
a power transmission mode that transmits an electric power on the basis of a request from the other power receiving device or a power transmission and receiving device, and a detection mode that detects the other power receiving device or the power transmission and receiving device, and
in the detection mode, the electric power is not transmitted.

15. The method for detecting power receiving device according to claim 13, wherein
the detected signal data is a current value or a voltage value of the resonance circuit.

16. The method for detecting power receiving device according to claim 13, wherein
the control unit sets a plurality of resonance frequencies of the resonance circuit, and
the resonance frequencies are set to correspond to the three or more drive frequencies, respectively.

17. The method for detecting power receiving device according to claim 16, wherein
the control unit compares the maximum values of the currents or the voltages at the resonance frequencies with each other to detect the power receiving device.

18. The method for detecting power receiving device according to claim 13, wherein
the control unit sequentially sets three frequencies as the drive frequencies and measures the signal data,
a first drive frequency is a frequency higher than a second drive frequency and lower than a third drive frequency,
the first drive frequency is set after the second and third drive frequencies are set and the signal data is measured, and the corresponding signal data is measured.

19. A power receiving device detection program for noncontact charging including a storage unit in which a program is stored and a control unit having a processing unit that develops and executes the stored program, when an electric power is transmitted from a power transmission device to a power receiving device in a noncontact state by using a resonance circuit, the power receiving device detecting program detecting the presence/absence of the power receiving device comprising:
the step of setting a drive frequency of a signal for driving a resonance circuit by the control unit;
the step of driving the resonance circuit at three or more drive frequencies on the basis of a setting of the control unit by a drive unit;
the step of detecting a drive waveform of the resonance circuit by a drive waveform detecting unit, wherein
the control unit sets three or more drive frequencies, compares signal data at the drive frequencies detected by the drive waveform detecting unit with each other, and detects the power receiving device on the basis of the comparison result.

20. The power receiving device detecting program according to claim 19, wherein
the control unit includes
a power transmission mode that transmits an electric power on the basis of a request from the other power receiving device or a power transmission and receiving device, and a detection mode that detects the other power receiving device or the power transmission and receiving device, and
in the detection mode, the electric power is not transmitted.

21. The power receiving device detection program according to claim 19, wherein
the detected signal data is a current value or a voltage value of the resonance circuit.

22. The power receiving device detection program according to claim 19, wherein
the control unit sets a plurality of resonance frequencies of the resonance circuit, and
the resonance frequencies are set to correspond to the three or more drive frequencies, respectively.

23. The power receiving device detection program according to claim 22, wherein
the control unit compares the maximum values of the currents or the voltages at the resonance frequencies with each other to detect the power receiving device.

24. The power receiving device detection program according to claim 19, wherein
the control unit sequentially sets three frequencies as the drive frequencies and measures the signal data,
a first drive frequency is a frequency higher than a second drive frequency and lower than a third drive frequency,
the first drive frequency is set after the second and third drive frequencies are set and the signal data is measured, and the corresponding signal data is measured.
first, second, and third maximum values are not equal to each other.

25. A semiconductor device comprising
a storage unit in which the power receiving device detection program according to claim 19 is stored.

26. The semiconductor device according to claim 25, further comprising
a control unit that develops and executes the received power adjustment program.

27. The power transmission device according to claim 6, wherein
when signal data measured by setting the first drive frequency is smaller than signal data measured by setting the second and third drive frequencies, the device is authenticated as a communication target.

28. The power transmission device according to claim 6, wherein
a first maximum value which is largest in signal data measured by setting the first, second, and third drive frequencies, a second maximum value which is largest in signal data measured by setting the first, second, and third drive frequencies to frequencies lower by predetermined frequencies, respectively, and a third maximum value which is largest in signal data measured by setting the first, second, and third drive frequencies to frequencies higher by predetermined frequencies, respectively, are compared with each other, the device is not authenticated as a communication target when the first, second, and third maximum values are equal to each other, and the device is authenticated as a communication target when the first, second, and third maximum values are not equal to each other.

29. The power transmission device according to claim 12, wherein
when signal data measured by setting the first drive frequency is smaller than signal data measured by setting the second and third drive frequencies, the device is authenticated as a communication target.

30. The power transmission device according to claim 12, wherein
a first maximum value which is largest in signal data measured by setting the first, second, and third drive frequencies, a second maximum value which is largest in signal data measured by setting the first, second, and third drive frequencies to frequencies lower by predetermined frequencies, respectively, and a third maximum value which is largest in signal data measured by setting the first, second, and third drive frequencies to frequencies higher by predetermined frequencies, respectively, are compared with each other, the device is not authenticated as a communication target when the first, second, and third maximum values are equal to each other, and the device is authenticated as a communication target when the first, second, and third maximum values are not equal to each other.

31. The power transmission device according to claim 18, wherein
when signal data measured by setting the first drive frequency is smaller than signal data measured by setting the second and third drive frequencies, the device is authenticated as a communication target.

32. The power transmission device according to claim 18, wherein
a first maximum value which is largest in signal data measured by setting the first, second, and third drive frequencies, a second maximum value which is largest in signal data measured by setting the first, second, and third drive frequencies to frequencies lower by predetermined frequencies, respectively, and a third maximum value which is largest in signal data measured by setting the first, second, and third drive frequencies to frequencies higher by predetermined frequencies, respectively, are compared with each other, the device is not authenticated as a communication target when the first, second, and third maximum values are equal to each other, and the device is authenticated as a communication target when the first, second, and third maximum values are not equal to each other.

33. The power transmission device according to claim 24, wherein
when signal data measured by setting the first drive frequency is smaller than signal data measured by setting the second and third drive frequencies, the device is authenticated as a communication target.

34. The power transmission device according to claim 24, wherein
a first maximum value which is largest in signal data measured by setting the first, second, and third drive frequencies, a second maximum value which is largest in signal data measured by setting the first, second, and third drive frequencies to frequencies lower by predetermined frequencies, respectively, and a third maximum value which is largest in signal data measured by setting the first, second, and third drive frequencies to frequencies higher by predetermined frequencies, respectively, are compared with each other, the device is not authenticated as a communication target when the first, second, and third maximum values are equal to each other, and the device is authenticated as a communication target when the first, second, and third maximum values are not equal to each other.
